(19) United States
(12) Patent Application Publication
(10) Pub. No.: US 2017/0282799 A1
(43) Pub. Date: Oct. 5, 2017

(54) DRIVING SUPPORT DEVICE

(71) Applicant: Yazaki Corporation, Tokyo (JP)

(72) Inventor: Hideki MIYASAKA, Shizuoka (JP)

(73) Assignee: Yazaki Corporation, Tokyo (JP)

(21) Appl. No.: 15/470,121

(22) Filed: Mar. 27, 2017

(30) Foreign Application Priority Data
Mar. 30, 2016 (JP) 2016-067412

(51) Int. Cl. B60R 1/00; H04N 7/18; H04N 5/232; G03B 29/00; G03B 21/28

(52) U.S. Cl. CPC B60R 1/00; G03B 29/00; G03B 21/28; H04N 5/23293; H04N 7/183; B60W 2300/34; B60R 2300/202

(57) ABSTRACT

A driving support device includes a projector and a screen in a cabin. The projector projects an image based on driving support information serving as assistance at the time of driving a vehicle. The screen includes a projection part on which the image based on the driving support information projected from a projecting unit of the projector is projected. The projecting unit of the projector and the projection part of the screen are disposed in a lower side of the vehicle with respect to an eye point of a driver, and the projecting unit of the projector is disposed in a lower side of the vehicle with respect to the gravity center position of the projection part of the screen. The projector is disposed so that reflection light related to an image based on the driving support information incident from the projecting unit reaches the eye point of the driver.

### CROSS-REFERENCE TO RELATED APPLICATION(S)

The present application claims priority to and incorporates by reference the entire contents of Japanese Patent Application No. 2016-067412 filed in Japan on Mar. 30, 2016.

### BACKGROUND OF THE INVENTION

### 1. Field of the Invention

The present invention relates to a driving support device.

### 2. Description of the Related Art

Conventionally, there has been known a driving support device that supports a driver by displaying driving support information in a cabin of a vehicle at the time of driving the vehicle. For example, Japanese Patent Application Laid-open No. 2010-179700 and Japanese Patent Application Laid-open No. 2005-184225 disclose a technique for displaying an image of driving support information projected from a projector on a screen in a cabin through a reflector such as a mirror.

In the conventional driving support device, there is room for improvement in the visibility of driving support information displayed in a cabin.

### SUMMARY OF THE INVENTION

An object of the present invention is to provide a driving support device capable of improving the visibility of driving support information in a cabin.

In order to achieve the above mentioned object, a driving support device according to one aspect of the present invention includes a projector that is disposed in a cabin and projects an image based on driving support information serving as assistance at a time of driving a vehicle; and a screen that is disposed in the cabin and includes a projection part on which the image based on the driving support information projected from a projecting unit of the projector is projected, wherein the projecting unit of the projector and the projection part of the screen are disposed in a lower side of the vehicle with respect to an eye point of a driver, and the projecting unit of the projector is disposed in a lower side of the vehicle with respect to a gravity center position of the projection part of the screen, and the projector is disposed so that reflection light that is related to the image based on the driving support information incident from the projecting unit to the projection part of the screen and is from the projection part of the screen reaches the eye point of the driver.

According to another aspect of the present invention, in the driving support device, it is desirable that the projection part of the screen is a virtual screen area that uses a part of or all of a wall surface of a dashboard facing a passenger seat side or a part of or all of a wall surface of a center console part, and the projecting unit of the projector is disposed on a wall surface inside the cabin facing a passenger seat side door.

According to still another aspect of the present invention, in the driving support device, it is desirable that the projection part of the screen is a virtual screen area that uses a part of or all of a wall surface inside the cabin facing a passenger seat side door, and the projecting unit of the projector is disposed on a dashboard.

In order to achieve the above mentioned object, a driving support device according to still another aspect of the present invention includes a projector that is disposed in a cabin and projects an image based on driving support information serving as assistance at a time of driving a vehicle; a reflector that is disposed in a cabin and reflects the image based on the driving support information projected from a projecting unit of the projector; and a screen that is disposed in the cabin and includes a projection part on which the image based on the driving support information reflected from a reflecting unit of the reflector is projected, wherein the reflecting unit of the reflector and the projection part of the screen are disposed in a lower side of the vehicle with respect to an eye point of a driver and a gravity center position of the reflecting unit of the reflector is disposed in a lower side of the vehicle with respect to the gravity center position of the projection part of the screen, and the reflector is disposed so that reflection light that is related to the image based on the driving support information incident from the reflecting unit to the projection part of the screen and is from the projection part of the screen reaches the eye point of the driver.

According to still another aspect of the present invention, in the driving support device, it is desirable to further includes an imaging device that images information on a vehicle periphery outside the vehicle as the driving support information.

According to still another aspect of the present invention, in the driving support device, it is desirable that the imaging device images at least information on a blind area on a passenger seat side viewed from a driver seat as the information on the vehicle periphery, and at least the image of the information on the blind area is projected on the projection part of the screen.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a driving support device in accordance with an embodiment of the present invention;

FIG. 2 is a view illustrating arrangement of a projecting unit of a projector and a projection part of a screen with respect to an eye point of a driver;

FIG. 3 is a view illustrating an example of arrangement of the projecting unit and the projection part viewed from a side surface of a vehicle;

FIG. 4 is a view illustrating an example of the arrangement of the projecting unit and the projection part viewed from the upper surface of the vehicle;

FIG. 5 is a conceptual diagram illustrating an example of an image projected with the arrangement of FIGS. 3 and 4;

FIG. 6 is a view illustrating an example of arrangement of the projecting unit and the projection part viewed from a side surface of the vehicle;

FIG. 7 is a view illustrating an example of the arrangement of the projecting unit and the projection part viewed from the upper surface of the vehicle;

FIG. 8 is a conceptual diagram illustrating an example of an image projected with the arrangement of FIGS. 6 and 7; and

FIG. 9 is a block diagram illustrating a modification of the driving support device in accordance with the embodiment.

### DETAILED DESCRIPTION OF THE PREFERRED EMBODIMENT

An embodiment of a driving support device according to the present invention will now be described in detail with reference to the accompanying drawings. It should be noted that this embodiment is not limited to the present invention.

### Embodiment

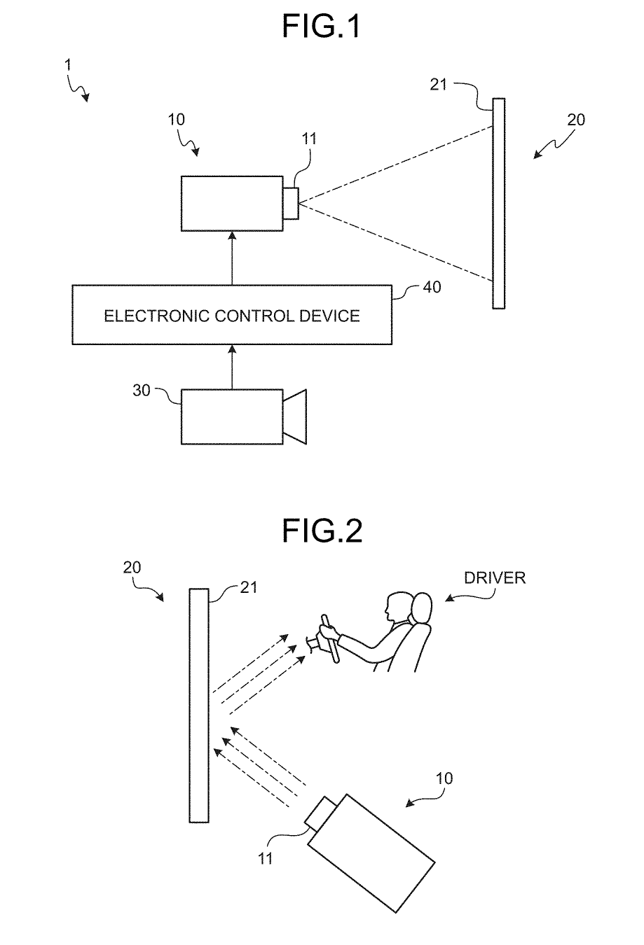

One of the embodiments of the driving support device according to the present invention will be described based on FIGS. 1 to 9.

A reference numeral 1 in FIG. 1 illustrates a driving support device of the embodiment. The driving support device 1 of the embodiment provides a driver with driving support information serving as assistance at the time of driving a vehicle, and displays an image (a still image or a moving image) based on the driving support information in a cabin of the vehicle so as to support driving of the driver.

Various types of the driving support information are acceptable if the information supports driving of the driver. Examples of the driving support information are considered to include information on a vehicle periphery outside the vehicle, information obtained by communication with the outside of the vehicle such as vehicle-to-vehicle communication and road-to-vehicle communication, map information and route information in a car navigation system, and information on the vehicle. The embodiment exemplifies the information on a vehicle periphery outside the vehicle displayed as the driving support information. Specifically, the information on the vehicle periphery outside the vehicle represents a moving object or a fixed object that is present in the periphery of the vehicle. The moving object means an object that moves in a periphery of the vehicle such as other traveling vehicles and pedestrians. The fixed object means an object that is fixed such as other stopping vehicles, persons stopping to wait for a signal and the like, and real estate (roads, buildings, installations, and the like).

The driving support device 1 includes a projector 10 that is disposed in the cabin and projects an image based on the driving support information, and a screen 20 that is disposed in the cabin and on which the image based on the driving support information projected from the projector 10 is displayed.

The projector 10 is a projection display device that projects an image from a projecting unit 11. The projector 10 of the embodiment is disposed so as to project an image from the projecting unit 11 to a projection part 21, which will be described later, of the screen 20. Thus, an image projected from the projecting unit 11 is directly projected to the projection part 21.

The screen 20 includes the projection part 21 on which an incident image is projected. On the projection part 21, an image projected from the projecting unit 11 of the projector 10 is projected. When receiving the projection light projected from the projecting unit 11 of the projector 10, the projection part 21 of the embodiment reflects the projection light. In this manner, when the reflection light reaches the eyes of the driver, the driver can visually recognize the image projected on the projection part 21. A reflection-type that regularly reflects projection light is used for this exemplary screen 20. Thus, in this screen 20, the projection part 21 is formed depending on the specifications of the screen 20. This screen 20 may be formed as a dedicated component and be disposed in the cabin, and may be a virtual screen using a wall surface in the cabin (hereinafter, referred to as a “virtual screen”). The embodiment exemplifies the screen 20 as the latter visual screen. Thus, surface treatment such as microfabrication, coating, and the like satisfying the above-mentioned specifications is applied to at least a part used as the projection part 21 on a wall surface in the cabin.

This driving support device 1 also includes an imaging device 30 that images the information on the vehicle periphery outside the vehicle, and regards at least the information on the vehicle periphery outside the vehicle to be a target projected to the screen 20 as an object to be imaged. At least one imaging device 30 is disposed outside the vehicle (outer plate and the like of the vehicle) or inside the cabin depending on an angle of view and an object to be imaged. The driving support device 1 of the embodiment causes the imaging device 30 to image at least information on a blind area on a passenger seat side viewed from a driver seat side as the information on the vehicle periphery, and an image based on the information on a blind area to be projected on the projection part 21. The information on a blind area means information on the outside of the vehicle that is hidden by a structure on the vehicle and fails to be visually recognized at the time of viewing the passenger seat side from the driver seat side, and includes not only information on the outside of the vehicle that is interrupted by a side of the vehicle but also information on the outside of the vehicle that is interrupted by the oblique front of the vehicle. Thus, the imaging device 30 is disposed on the front end side of the vehicle and the side surface on the passenger seat side of the vehicle (for example, a structure, what is called a pillar, on a side surface of the vehicle in a vehicle body framework), a corner on the front end on the passenger seat side of the vehicle, and the like. The image based on the information on a blind area includes at least the information on the blind area. Thus, at least the image of the information on a blind area is projected on the projection part 21. This imaging device 30 generates the imaged projection as imaged projection information.

For example, when imaging only the information on a blind area on the passenger seat side, the imaging device 30 generates an image of the information on a blind area as imaged projection information. When imaging the information on a blind area on the passenger seat side and information on the outside of the vehicle for a periphery of the vehicle originating the blind area as a starting point (for example, the center) (in other words, information which the driver can visually recognize from a side window and the like), the imaging device 30 generates an image that is formed of the information on a blind area on the passenger seat side and the information on the outside of the vehicle for a periphery of the vehicle originating the blind area as a starting point as imaged image information. When imaging the information on a blind area on the passenger seat side and information on the outside of the vehicle for a periphery of the vehicle originating the blind area as a starting point, the imaging device 30 generates an image that is formed of the information on a blind area on the passenger seat side and information within a predetermined range of the information on the outside of the vehicle for a periphery of the vehicle originating the blind area as a starting point as imaged projection information.

The driving support device 1 is provided with an electronic control device 40 that connects the imaging device 30 to the projector 10. The electronic control device 40 generates an image projected from the projector 10. The electronic control device 40 of the embodiment receives imaged projection information from the imaging device 30, and, for example, performs image processing on the imaged projection information so as to make this imaged projection information suitable for an image of the projection part 21 of the screen 20. The electronic control device 40 transmits the imaged projection information (hereinafter, referred to as “projection image information”) on which the image processing is performed to the projector 10. The projector 10 projects an image corresponding to the projection image information from the projecting unit 11 to the projection part 21 of the screen 20.

For example, when received imaged image information includes only the information on a blind area on the passenger seat side, and only an image of the information on a blind area is projected on the projection part 21, the electronic control device 40 transmits image information of the information on a blind area as projection image information to the projector 10. When received imaged image information includes the information on a blind area on the passenger seat side and information on the outside of the vehicle for a periphery of the vehicle originating the blind area as a starting point, and only an image of the information on a blind area is projected on the projection part 21, the electronic control device 40 extracts at least image information of the information on a blind area from the imaged image information, and transmits the extracted image information of the information on a blind area as projection image information to the projector 10. By contrast, when received imaged image information includes the information on a blind area on the passenger seat side and information on the outside of the vehicle for a periphery of the vehicle originating the blind area as a starting point, the electronic control device 40 may transmit image information that is formed of the information on a blind area and the information on the outside of the vehicle for a periphery of the vehicle originating the blind area as a starting point as projection image information to the projector 10. In this case, the electronic control device 40 may extract image information that is formed of the information on a blind area and information within a predetermined range of the information on the outside of the vehicle for a periphery of the vehicle originating the blind area as a starting point from the imaged image information, and transmit the extracted image information as projection image information to the projector 10. In the driving support device 1 of the embodiment, such projection image information is transmitted to the projector 10 so as to project at least an image of the information on a blind area on the projection part 21.

The driving support device 1 of the embodiment improves the visibility of the driving support information to the driver in the cabin by disposing the projector 10 and the screen 20 as follows.

In this example, the information on a blind area on the passenger seat side viewed from the driver seat side is transmitted as driving support information to the driver. Thus, in order to reduce uncomfortable feeling of the driver, the projection part 21 of the screen 20 is preferably disposed on a wall surface on the passenger seat side viewed from the driver seat side in the cabin that is a structure on the vehicle forming the blind area. In other words, an image based on information on a blind area is desirably projected on a wall surface in the cabin forming the blind area. Thus, this exemplary projection part 21 is, out of wall surfaces on the passenger seat side viewed from the driver seat side in the cabin, provided to a wall surface of a structure with lower transmissivity that has lower transmissivity of light between the inside and the outside of the vehicle and is incapable of visually recognizing information on the outside of the vehicle from the cabin. The structure with lower transmissivity includes not only a structure that has transmissivity, but is difficult to visually recognize the outside of the vehicle from the cabin but also a structure that has no transmissivity. Examples of an arrangement place of the projection part 21 are considered to include a wall surface on the passenger seat side and the wall surface of the center console part in a dashboard, and a wall surface in the cabin on the passenger seat side (a door trim part except for a side window). The projection part 21 is provided to, out of a plurality of wall surfaces serving as candidates of the arrangement place, at least one wall surface.

In a structure on the passenger seat side of the vehicle, a light transmission member transmitting light between the inside and the outside of the vehicle such as a front window and a side window is present. Projection light from the projecting unit 11 is roughly divided into light transmitted to the outside of the vehicle and light reflected into the cabin through the light transmission member. The driver may recognize an image projected on the light transmission member depending on a light path of reflection light, and feel troublesome due to balance with the scenery outside the vehicle that is seen from the light transmission member. Thus, the projection part 21 is desirably provided to a place except a wall surface of the light transmission member in the cabin. However, the projection part 21 may be provided over a wall surface of the light transmission member if the driver cannot visually recognize an image projected on the light transmission member.

The projection part 21 may fail to be secured as a well-formed area such as a rectangle depending on the shape and the arrangement of the dashboard, a wall surface in the cabin facing a passenger seat side door, and a passenger seat. In this case, the projection part 21 may be formed as a well-formed area by defining a wall surface serving as an arrangement place as a major area of the projection part 21 and including a wall surface of peripheral components and the like in the area of the projection part 21. If a part of an image projected from the projecting unit 11 (for example, a part of a corner and the like) does not interfere visibility to the driver, the part may be projected on, for example, a seat surface of the passenger seat and a floor mat on the passenger seat side. The projection part 21 is not necessarily provided as a well-formed area.

As described above, the projection part 21 is provided to a wall surface on the passenger seat side or the wall surface of the center console part in the dashboard, or a wall surface in the cabin facing the passenger seat side door (a part with low transmissivity). Regardless of distinction among automobiles, large-sized vehicles (trucks, buses, and the like), and the like, in a general vehicle, the projection part 21 is disposed in a lower side of the vehicle with respect to the eye point of the driver. Considering this point, in the driving support device 1 of the embodiment, the projector 10 and the screen 20 are disposed so that reflection light from the projection part 21 reaches the eye point of the driver.

In the driving support device 1, the projecting unit 11 of the projector 10 and the projection part 21 of the screen 20 are disposed in a lower side of the vehicle with respect to the eye point of the driver, and the projecting unit 11 is disposed in a lower side of the vehicle with respect to a gravity center position of the projection part 21. The projector 10 is disposed so that reflection light that is related to an image incident from the projecting unit 11 to the projection part 21 of the screen 20 and is from the projection part 21 of the screen 20 reaches the eye point of the driver. The gravity center position of the projection part 21 corresponds to, in other words, the center position of an image projected from the projecting unit 11 on the projection part 21. For example, when a rectangle in an image is projected, a part of the wall surface on the center position of the rectangle is projected is considered to be the gravity center position of the projection part 21.

The projection part 21 of the screen 20 receives projection light of an image projected from the projecting unit 11 of the projector 10, and emits this incident projection light as reflection light. This exemplary screen 20 forms the projection part 21 so as to regularly reflect projection light as described above. Thus, the projector 10 and the screen 20 are disposed in a lower side of the vehicle with respect to the eye point of the driver so that an incident angle of projection light and a reflection angle of reflection light in the projection part 21 are substantially the same and the reflection light reaches the eye point of the driver (FIG. 2). For the driver, the luminance of an image based on driving support information projected on the projection part 21 is relatively higher than, for example, that in a case where the image is projected from the ceiling, and the driving support device 1 can improve the visibility of the driving support information to the driver in the cabin.

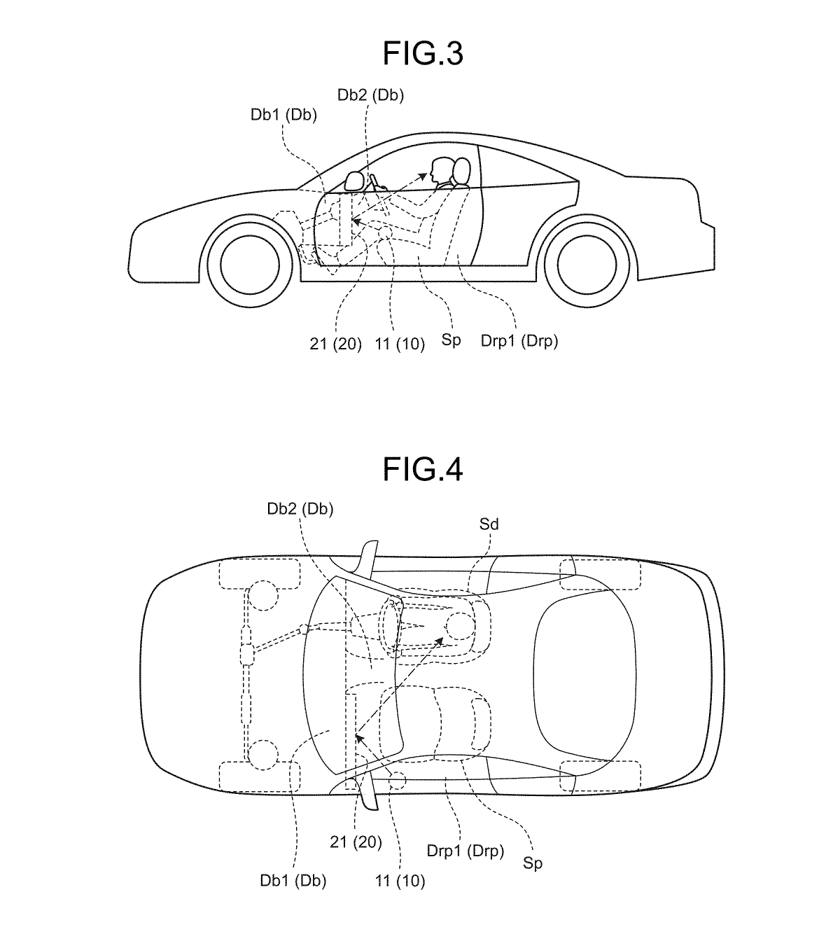

Specifically, the following describes the projection part 21 of the screen 20 that is provided to a dashboard Db on a passenger seat Sp side viewed from a driver seat Sd side (FIGS. 3 and 4).

As described above, the screen 20 of the embodiment is a virtual screen. In this case, the projection part 21 uses a part of or all of the wall surface Db1 on the passenger seat Sp side and/or a part of or all of a wall surface Db2 of a center console part in the dashboard Db, and uses the wall surfaces Db1 and Db2 as a virtual screen area. The projection part 21 is disposed at a position that can be visually recognized by the driver out of the wall surfaces Db1 and Db2, the position being determined based on the shape of the dashboard Db. In FIGS. 3 and 4, on the wall surface Db1 on the passenger seat Sp side, a part facing the backrest of the passenger seat Sp is defined as the projection part 21.

By contrast, in this case, the projector 10 has the projecting unit 11 disposed on a wall surface Drp1 in the cabin facing the passenger seat side door Drp so that reflection light from the projection part 21 is directed to the eye point of the driver. The projecting unit 11 of the passenger seat side door Drp is disposed, in the wall surface Drp1, in a lower side of the vehicle with respect to the gravity center position of the projection part 21 of the dashboard Db. Thus, the arrangement place and the size of the projecting unit 11 and the projection part 21 are defined depending on the shape and the arrangement of the passenger seat Sp, the wall surface Drp1 in the cabin facing the passenger seat side door Drp, and the dashboard Db so that projection light from the projecting unit 11 can reach the projection part 21 and the reflection light of the projection light in the projection part 21 can reach the eye point of the driver. On the passenger seat Sp, a passenger may be seated or baggage may be placed. Considering this point, the arrangement place and the size of the projecting unit 11 and the projection part 21 are preferably defined so that the passenger or the baggage on the passenger seat Sp does not interrupt the projection light. In this manner, this projector 10 can project an image from the projecting unit 11 of the passenger seat side door Drp on a virtual screen area of the dashboard Db as the projection part 21.

In the driving support device 1, the reflection light of the projection light projected from the projecting unit 11 of the passenger seat side door Drp can reach the eye point of the driver at the projection part 21 of the dashboard Db by adopting such arrangement of the projector 10 and the screen 20. In this manner, for the driver, the luminance of an image based on driving support information projected on the projection part 21 is higher than that of projection light from any other place, and the driving support device 1 can improve the visibility of the driving support information to the driver in the cabin.

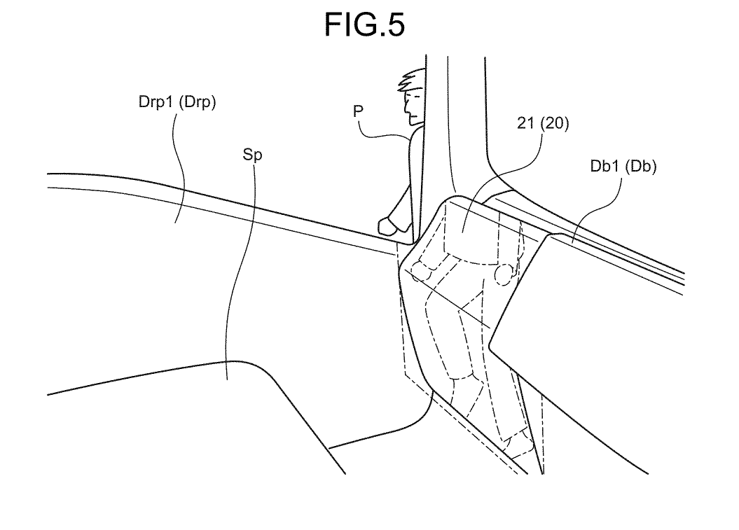

FIG. 5 illustrates an example of an image projected by the projection part 21 of the dashboard Db as an image. FIG. 5 illustrates that a pedestrian P walks on the side of the vehicle on the passenger seat Sp side from the front side of the vehicle toward this side, and the pedestrian P enters a blind area of the driver (blind area formed by the A pillar).

In the driving support device 1, the imaging device 30 images the information on the vehicle periphery including the pedestrian P. This exemplary imaging device 30 images, for example, the information on a blind area on the passenger seat Sp side of the vehicle including the pedestrian P, and information on the outside of the vehicle for a periphery on the passenger seat Sp side originating the blind area as a starting point (for example, the center), and generates an image of the information on a blind area and the information on the outside of the vehicle for a periphery as imaged image information. This exemplary electronic control device 40 extracts image information that includes the information on a blind area on the passenger seat Sp side and information within a predetermined range of the information on the outside of the vehicle for a periphery on the passenger seat Sp side originating the blind area as a starting point from the imaged image information, and transmits the extracted image information as projection image information to the projector 10. The projector 10 projects an image corresponding to the projection image information from the projecting unit 11 on the passenger seat Sp toward the projection part 21 of the dashboard Db. At this time, the driver can visually recognize the image projected on the projection part 21, and can recognize, based on this image, the information on a blind area on the passenger seat Sp side and information within a predetermined range of the information on the outside of the vehicle for a periphery on the passenger seat Sp side originating the blind area as a starting point.

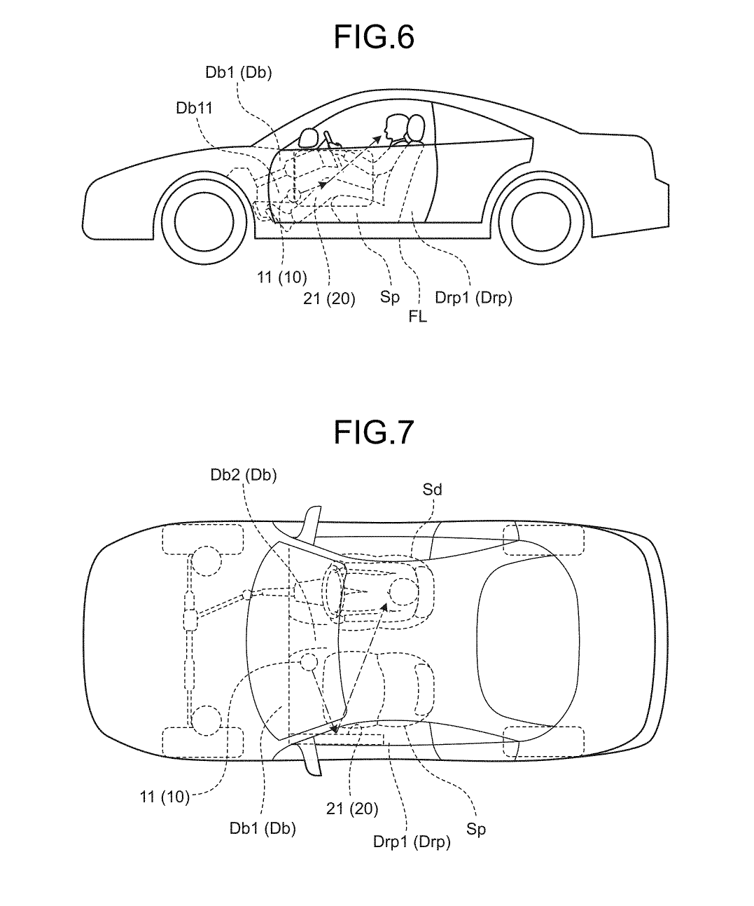

The following describes the projection part 21 of the screen 20 that is provided to the passenger seat side door Drp in the cabin (FIGS. 6 and 7).

In this case, the projection part 21 uses a part of or all of the wall surface Drp1 in the cabin facing the passenger seat side door Drp, and uses the wall surface Drp1 as a virtual screen area. The projection part 21 is disposed at a position that can be visually recognized by the driver in the wall surface Drp1, the position being determined based on the shape of the wall surface Drp1 and the shape and the position of the passenger seat Sp. For example, an image is projected on a lined part and the like of the passenger seat side door Drp.

In this case, the projector 10 is disposed on the wall surface (for example, the wall surfaces Db1 and Db2) of the dashboard Db so that reflection light from the projection part 21 is directed to the eye point of the driver. The projecting unit 11 of the dashboard Db is disposed, in the wall surface, in a lower side of the vehicle with respect to the gravity center position of the projection part 21 of the passenger seat side door Drp. Thus, the arrangement place of the projecting unit 11 and the arrangement place and the size of the projection part 21 are defined depending on the shape and the arrangement of the passenger seat Sp, the wall surface Drp1 in the cabin facing the passenger seat side door Drp, and the dashboard Db so that projection light from the projecting unit 11 can reach the projection part 21 and the reflection light of the projection light in the projection part 21 can reach the eye point of the driver. In addition, the arrangement place of the projecting unit 11 and the arrangement place and the size of the projection part 21 are desirably defined so that the passenger or the baggage on the passenger seat Sp does not interrupt the projection light. For example, the projecting unit 11 is disposed on a wall surface Db11 at the passenger seat Sp side and in a lower side of the vehicle (in other words, a wall surface on a floor panel FL side), and the wall surface Db2 of the center console part in the dashboard Db. In this manner, this projector 10 can project an image from the projecting unit 11 of the dashboard Db on a virtual screen area of the passenger seat side door Drp as the projection part 21.

In the driving support device 1, the reflection light of the projection light projected from the projecting unit 11 of the dashboard Db can reach the eye point of the driver at the projection part 21 of the passenger seat side door Drp by adopting such arrangement of the projector 10 and the screen 20. In this manner, for the driver, the luminance of an image based on driving support information projected on the projection part 21 is higher than that of projection light from any other place, and the driving support device 1 can improve the visibility of the driving support information to the driver in the cabin.

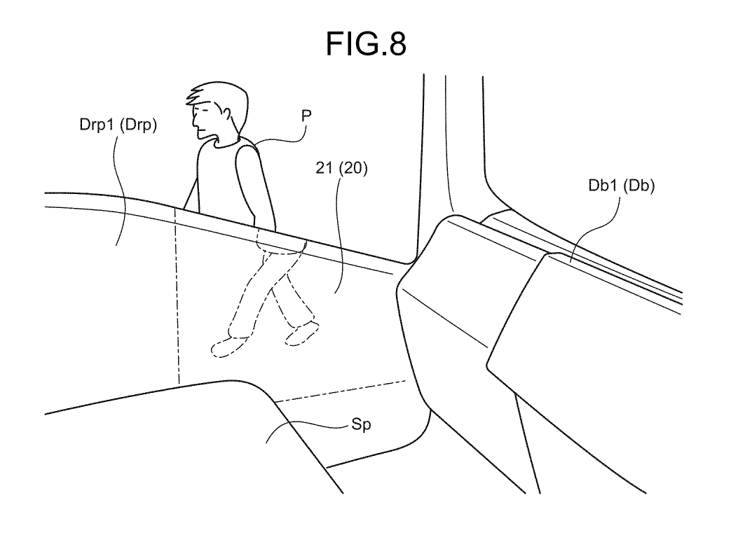

FIG. 8 illustrates an example of an image projected on the projection part 21 of the passenger seat side door Drp as an image. FIG. 8 illustrates that the pedestrian P walks on the side of the vehicle on the passenger seat Sp side from the front side of the vehicle toward this side, and the pedestrian P reaches the side of the passenger seat side door Drp. This exemplary driver can visually recognize the upper body of the pedestrian P from the side window of the passenger seat side door Drp, but cannot visually recognize the lower body of the pedestrian P because of an outer plate, a lining, and the like of the passenger seat side door Drp. For example, FIG. 8 exemplifies the pedestrian P who is an adult, but when the pedestrian P is a young child, the pedestrian P may be hidden by an outer plate and the like of the passenger seat side door Drp and is unlikely to be recognized by the driver.

In the driving support device 1, similarly to the previous example, the imaging device 30 performs imaging, the electronic control device 40 performs arithmetic processing, and the projector 10 performs projecting, and an image that is formed of the information on a blind area on the side of the vehicle of the passenger seat side door Drp including the pedestrian P and information within a predetermined range of information on the outside of the vehicle for a periphery on the passenger seat Sp side originating the blind area (for example, the center) as a starting point is projected on the projection part 21 of the passenger seat side door Drp. The driver in this case can visually recognize the image projected on the projection part 21, and can recognize, based on this image, the information on a blind area on the side of the vehicle of the passenger seat side door Drp and the information within a predetermined range of the information on the outside of the vehicle for a periphery on the passenger seat Sp side originating the blind area as a starting point.

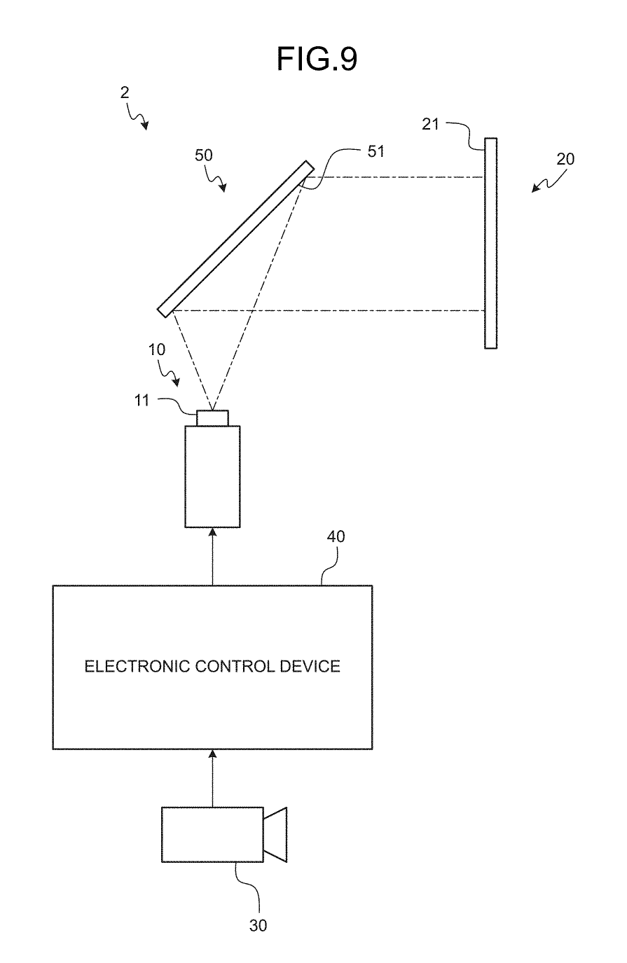

The driving support device 1 of the embodiment is exemplified as a device that causes the projecting unit 11 of the projector 10 to directly project an image on the projection part 21 of the screen 20. However, in a technical field of the projector, a reflector such as a mirror may be interposed between a projecting unit and a projection part. A driving support device 2 illustrated in FIG. 9 has such configuration.

The driving support device 2 is the driving support device 1 having a reflector 50 interposed between the projecting unit 11 of the projector 10 and the projection part 21 of the screen 20. The reflector 50 includes a reflecting unit 51 that reflects incident light. This reflector 50 is disposed in the cabin so as to reflect an image based on driving support information projected from the projecting unit 11 and emit the reflection light to the projection part 21. In this manner, an image reflected from the reflecting unit 51 is projected on the projection part 21 in the driving support device 2.

In the driving support device 2, the reflecting unit 51 of the reflector 50 and the projection part 21 of the screen 20 are disposed in a lower side of the vehicle with respect to the eye point of the driver, and the gravity center position of the reflecting unit 51 is disposed in a lower side of the vehicle with respect to the gravity center position of the projection part 21. In addition, the reflector 50 is disposed so that reflection light that is related to an image incident from the reflecting unit 51 to the projection part 21 and is from the projection part 21 reaches the eye point of the driver.

The gravity center position of the projection part 21 is the same as that described as above, and corresponds to the center position of an image projected on the projection part 21 through the reflecting unit 51. The gravity center position of the reflecting unit 51 corresponds to the center position of an image projected on the reflecting unit 51 by projection light from the projecting unit 11. The reflecting unit 51 in the driving support device 2 may be disposed at, for example, a position the same as that of the projecting unit 11 in the driving support device 1, and a position where the emitting direction of the reflection light from the reflecting unit 51 and the emitting direction of the projection light from the projecting unit 11 in the driving support device 1 are directed in the same direction. In this case, the projecting unit 11 in the driving support device 2 is disposed at a position capable of forming reflection light from the reflecting unit 51.

Such configuration enables the driving support device 2 to have the same effects as that of the above-mentioned driving support device 1. In the above-mentioned driving support device 1, there are assumed some cases, for example, a case where the projecting unit 11 is hardly disposed at a position capable of directly projecting projection light on the projection part 21 depending on the size and the positional relation of the passenger seat Sp, the wall surface Drp1 in the cabin facing the passenger seat side door Drp, and the dashboard Db, and a case where the projecting unit 11 is hardly disposed at a position capable of securing a projection part with a desired size (size of a displayed image) in the projection part 21. However, considering this configuration, the driving support device 2 including the reflector 50 further enhances the flexibility in the arrangement of the projecting unit 11 (projector 10) than a case where only the driving support device 1 is defined as a candidate applied to the vehicle. From this point, the driving support device 2 contributes to improve the visibility of the driving support information to the driver in the cabin.

In the driving support device according to the present embodiment, the projector and the screen are disposed as described above, and the projection part of the screen makes the reflection light of the projection light projected from the projecting unit of the projector reach the eye point of the driver. Thus, for the driver, the luminance of an image based on driving support information projected on the projection part is higher than that of projection light from any other place. In this manner, this driving support device can improve the visibility of the driving support information to the driver in the cabin.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A driving support device comprising:
a projector that is disposed in a cabin and projects an image based on driving support information serving as assistance at a time of driving a vehicle; and
a screen that is disposed in the cabin and includes a projection part on which the image based on the driving support information projected from a projecting unit of the projector is projected, wherein
the projecting unit of the projector and the projection part of the screen are disposed in a lower side of the vehicle with respect to an eye point of a driver, and the projecting unit of the projector is disposed in a lower side of the vehicle with respect to a gravity center position of the projection part of the screen, and
the projector is disposed so that reflection light that is related to the image based on the driving support information incident from the projecting unit to the projection part of the screen and is from the projection part of the screen reaches the eye point of the driver.

2. The driving support device according to claim 1, wherein
the projection part of the screen is a virtual screen area that uses a part of or all of a wall surface of a dashboard facing a passenger seat side or a part of or all of a wall surface of a center console part, and
the projecting unit of the projector is disposed on a wall surface inside the cabin facing a passenger seat side door.

3. The driving support device according to claim 1, wherein
the projection part of the screen is a virtual screen area that uses a part of or all of a wall surface inside the cabin facing a passenger seat side door, and
the projecting unit of the projector is disposed on a dashboard.

4. The driving support device according to claim 1, further comprising:
an imaging device that images information on a vehicle periphery outside the vehicle as the driving support information.

5. The driving support device according to claim 2, further comprising:
an imaging device that images information on a vehicle periphery outside the vehicle as the driving support information.

6. The driving support device according to claim 3, further comprising:
an imaging device that images information on a vehicle periphery outside the vehicle as the driving support information.

7. A driving support device comprising:
a projector that is disposed in a cabin and projects an image based on driving support information serving as assistance at a time of driving a vehicle;
a reflector that is disposed in a cabin and reflects the image based on the driving support information projected from a projecting unit of the projector; and
a screen that is disposed in the cabin and includes a projection part on which the image based on the driving support information reflected from a reflecting unit of the reflector is projected, wherein
the reflecting unit of the reflector and the projection part of the screen are disposed in a lower side of the vehicle with respect to an eye point of a driver and a gravity center position of the reflecting unit of the reflector is disposed in a lower side of the vehicle with respect to the gravity center position of the projection part of the screen, and
the reflector is disposed so that reflection light that is related to the image based on the driving support information incident from the reflecting unit to the projection part of the screen and is from the projection part of the screen reaches the eye point of the driver.

8. The driving support device according to claim 7, further comprising:
an imaging device that images information on a vehicle periphery outside the vehicle as the driving support information.

9. The driving support device according to claim 8, wherein
the imaging device images at least information on a blind area on a passenger seat side viewed from a driver seat as the information on the vehicle periphery, and
at least the image of the information on the blind area is projected on the projection part of the screen.
